(19) United States
(12) Patent Application Publication
(10) Pub. No.: US 2005/0079301 A1
(43) Pub. Date: Apr. 14, 2005

(54) Use of antiadhesive packaging materials for packaging chemicals and foodstuffs

(76) Inventors: York Hartleben, Friedelsheim (DE); Reinhard Weiss, Schwegenheim (DE)

Correspondence Address: Morrison & Foerster, 1650 Tysons Boulevard, Suite 300, McLean, VA, 22102-3915, US

(21) Appl. No.: 10/503,475

(22) PCT Filed: Jan. 30, 2003
(86) PCT No.: PCT/EP03/00922

(30) Foreign Application Priority Data
Feb. 4, 2002 (DE) 10204562.3

(51) Int. Cl. F16L 1/00; B32B 1/08

(52) U.S. Cl. 428/34.1; 428/34.8

(57) ABSTRACT

The present invention relates to the use of antiadhesive packaging materials for packaging chemicals and foodstuffs, especially fine chemicals such as vitamins, carotenoids, fragrances and flavors, and pharmaceutical chemicals, and also for their formulations and preparations.

The present invention relates to the use of antiadhesive packaging materials for packaging chemicals and foodstuffs, especially fine chemicals such as vitamins, carotenoids, fragrances and aromas, and pharmaceutical chemicals, for example, and also for their formulations and preparations.

Chemicals and foodstuffs are dispensed into cans, bottles, drums or other containers for transport, storage or sale. These containers have to date been coated by means of conventional coating materials or other coating techniques in order to ensure food-contact integrity, for example. A variety of coating systems are in use for this purpose, such as phenolic resins, phenol-formaldehyde resins or epoxy-phenol resins, for example. Alternatively use is also made of coatings with polymeric molding compounds (e.g. polyethylene).

Antiadhesive properties of surfaces—in part also referred to as the lotus effect—can be obtained by means of particular antiadhesive coating systems (e.g., DE-A-35 35 283, EP-A-0 835 897, JP-1 11 89701, U.S. Pat. No. 5,324,566). These coating systems, however, have various disadvantages: they necessitate high use concentrations, for example, are in some cases not resistant to hydrolysis or are difficult to handle.

Advantageous new additives having superior antiadhesive properties are described in the German patent application numbered 2 420 767 (filing date 09.29.2000). That description includes the use of the additived coating compositions for can interior coatings and drum interior coatings, in order to allow full discharge from corresponding oil-containing vessels. Mention is made, by way of example, of mineral oils and vegetable oils.

The preferred sphere of application for all antiadhesive coatings additives is in the industrial sector, generally in the production of self-cleaning surfaces or antigraffiti coatings, etc. For none of the antiadhesive coatings additives described in the prior art is there a description of its use for coating packaging materials for chemicals, especially fine chemicals, such as vitamins, carotenoids, fragrances and aromas, or pharmaceutical chemicals, for example.

One problem which exists in connection with the handling of chemicals and foodstuffs, particularly those having lipophilic properties, is the efficient full discharge of the containers accommodating them. Because of adhesion to the walls of the vessel, none of the systems employed to date is able to ensure full discharge, and so it is necessary to accept a loss of the valuable compounds. Moreover, packaging which has not been fully discharged cannot be immediately recycled. The requisite cleaning makes their re-use uneconomic.

The object of the present invention, accordingly, was to provide packaging materials for chemicals and foodstuffs, preferably lipophilic chemicals and fine chemicals, which ensure improved, as far as possible complete, full discharge. A further object was that the coating compositions employed should exhibit good mechanical strength, as a basic prerequisite for food-contact integrity.

Surprisingly this object has been achieved through using packaging materials prepared by the addition to conventional coating compositions or polymeric molding compounds of an antiadhesive additive comprising a branched polymer composed of a polymeric base molecule and polydiorganosiloxane side chains attached covalently to the base molecule, either directly or via a spacer (“antiadhesive additive” below).

The extremely low concentration of the antiadhesive additive needed for inventive use allows the use of coating compositions and polymeric molding compounds which are established and have been scrutinized over many years. The physical properties of the original coating compositions and polymeric molding compounds in respect, for example, of corrosion protection, gloss retention, weathering stability, and food-contact integrity are unaffected by the low concentrations of the antiadhesive additive.

The present invention first provides for the use of packaging materials for packaging chemicals and foodstuffs, excluding mineral and vegetable oils, said packaging materials comprising coating compositions and/or polymeric molding compounds which comprise a branched polymer (antiadhesive additive) composed of a polymeric base molecule and polydiorganosiloxane side chains attached covalently to the base molecule, directly or via a spacer. Preference is given to the packaging of fine chemicals. Great preference is given to the packaging of lipophilic fine chemicals.

The term “lipophilic chemical” or “lipophilic fine chemical” embraces those compounds which at 20° C. under atmospheric pressure have a water solubility of below 10 percent by weight (% by weight), preferably below 5% by weight, more preferably below 3% by weight, most preferably below 1% by weight.

“Fine chemicals” are all those specialty chemicals which have world annual production of below 200 000 t, preferably below 100 000 t, very preferably below 50 000 t. They include, for example, vitamins, fatty acids, fragrances, flavors, and aromas, colorants, pharmaceutical chemicals, agrochemicals, and cosmetic chemicals, precursors and intermediates thereof, and formulations and preparations of the above.

Fine chemicals include by way of example, but without limitation:

a) vitamins, especially lipophilic vitamins such as
tocopherols and tocotrienols (for the purposes of this invention together designated vitamin E) and derivatives thereof and also their compounds such as vitamin E acetate, vitamin E succinate or vitamin E nicotinate, for example. Included are both synthetic vitamin E and vitamin E obtained from natural sources, and derivatives thereof.
Vitamin A and its derivatives, such as retinol (vitamin A1) and compounds thereof, such as esters, e.g., acetates, palmitates, and propionates.
Vitamin D and its derivatives such as D3 (cholecalciferol) or D2 (ergocalciferol), and compounds thereof.
Vitamin K and its derivatives, such as vitamin K1 (phylloquinone), K2, K3 (menadione), K4 and K5, and compounds thereof.
Vitamin F and its derivatives, such as essential fatty acids (see below), and compounds thereof.

b) Fatty acids, such as saturated and unsaturated fatty acids and also derivatives and compounds thereof, especially
polyunsaturated fatty acids such as arachidonic acid, eicosapentaenoic acid or docosahexaenoic acid
conjugated polyunsaturated fatty acids such as conjugated linolenic acids (CLA; conjugated linoleic acid), α-parinaric acid (18:4 octadecatetraenoic acid), eleostearic acid (18:3 octadecatrienoic acid), dimorphecolic acid and calendula acid. CLA is a collective term for positional and structural isomers of linolenic acid which are characterized by a conjugated double bond system beginning at carbon atom 8, 9, 10 or 11. Geometric isomers exist for each of these positional isomers: cis-cis, trans-cis, cis-trans, trans-trans. Of particular interest are especially C18:2 cis-9, trans-11 and C18:2 trans-10, cis-12 CLAs, the most biologically active isomers, since in animal experiments they have proven cancer-preventing, act antiarteriosclerotically, and reduce the proportion of body fat in humans and animals.

c) Natural and synthetic flavors, aromas, and fragrances, especially lipophilic flavors, aromas, and fragrances, such as lysmeral, anisaldehyde, p-cresol methyl ether, citral, D-panthenol, acetoin, isoamyl acetate, anisylpropanal, citronellal, citronellol, citronellyl acetate, citronellyl nitrile, diacetyl, dimethylheptanol, geranonitrile, geranylacetone, Hydroxyciol, hydroxycitronellal, β-ionone, linalyl acetate, phytol, nerolidol, and isovaleraldehyde, linalool, menthol, borneon (camphor), pinene, limonene or geraniol, and derivatives and compounds of the above.

d) Colorants, especially lipophilic colorants, such as
retinoids (e.g. vitamin A),
flavonoids (e.g., quercetin, rutin, tangeretin, nobiletin)
carotenoids (e.g., β-carotene (provitamin A), apo-carotenal, lycopene, astaxanthin) and derivatives and compounds of the above.

e) Pharmaceutical chemicals, especially lipophilic pharmaceutical chemicals, and their derivatives, compounds, precursors or intermediates. Pharmaceutical chemicals are in general all such compounds which are used in or to prepare a human or veterinary drug. They include for example, but without limitation, the following:
anesthetics and narcotics such as butanilicaine, fomocaine, isobutamben, lidocaine, risocaine, prilocaine, pseudococaine, tetracaine, trimecaine, tropacocaine, and etomidate;
anticholinergics such as metixene and profenamine;
antidepressants, psychostimulants, and neuroleptics, such as alimenazine, binedaline, perazine, chlorpromazine, fenpentadiol, fenanisol, fluanisol, mebenazine, methylphenidate, thioridazine, toloxatone, and trimipramine;
antiepileptics such as dimethadione and nikethamide;
antimycotics such as butoconazole, chlorphenesin, etisazole, exalamide, pecilocin, and miconazole;
antiinflammatories such as butibufen and ibuprofen;
bronchodilators such as bamifylline;
cardiovascular drugs such as alprenolol, butobendine, cloridazole, hexobendine, nicofibrate, penbutolol, pirmenol, prenylamine, procaineamide, propatyl nitrate, suloctidil, toliprolol, xibendol, and viquidil;
cytostatics such as asperlin, chlorambucil, chlornaphazine, mitotane, estramustin, taxol, penclomedine, and trofosfamide;
hyperemics such as capsaicin and methyl nicotinate;
lipid regulating agents such as nicoclonate, oxprenolol, pirifibrate, simfibrate, and thiadenol;
spasmolytics such as aminopromazine, caronerine, difemerine, fencarbamide, tiropramide, and moxaverine;
testosterone derivatives such as testosterone enantate and testosterone (4-methylpentanoate);
tranquilizers such as azaperone and buramate;
virustatics such as arildone;

f) agrochemicals, especially lipophilic agrochemicals, such as insecticides, pesticides, nematocides, rodenticides molluscicides, growth regulators, and herbicides, and derivatives, precursors or intermediates thereof, such as acephate, cyfluthrin, azinphosphomethyl, cypermethrin, substituted phenylthiophosphates, fenclophos, permethrins, piperonal, tetramethrins, and trifluralins.

g) Cosmetic chemicals, especially defoamers, surface-active compounds, i.e., surfactants, emulsifiers, foam formers, and solubilizers, preservatives, perfume oils, opacifiers, actives, UV filters, care substances such as panthenol, collagen, protein hydrolyzates, α- and β-hydroxy carboxylic acids, stabilizers, pH regulators, viscosity regulators, gel formers, salts, humectants, refatting agents. Also embraced are anionic, cationic, neutral or amphiphilic polymers, especially silicone compounds such as polyalkylsiloxanes, polyarylsiloxanes, polyarylalkylsiloxanes, polyethersiloxanes, silicone resins or Dimethicone Copolyols (CTFA) and amino-functional silicone compounds such as Aminodimethicones (CTFA), and also the copolymers and graft polymers derived therefrom. Additionally embraced are formulations of the aforementioned substances and also the finished cosmetics, examples being cosmetic hair formulations such as hair treatments, mousses, hair gels or hairsprays, hair lotions, hair rinses, shampoos, hair emulsions, split-end repair fluids, neutralizers for permanent waves, hot-oil treatment preparations, conditioners or setting lotions, in skincare and bodycare products, bath foams and shower gels, oral and other hygiene formulations, sun protection products, and tanning products. Particular preference is given to oily or oil-containing cosmetics such as beauty lotions or bath oils, for example.

The most preferred lipophilic fine chemicals are vitamin E and vitamin A and also compounds thereof, such as vitamin E acetate, vitamin A palmitate or vitamin A propionate.

By a chemical or fine chemicals is meant, for example, pure substances, the amount of the respective compound in the pure substance being at least 95% by weight, preferably at least 98% by weight, more preferably at least 99% by weight.

By a chemical or fine chemical is meant, in addition, mixtures of at least two chemicals or fine chemicals or mixtures with other substances. Particular preference is given to mixtures of at least two lipophilic vitamins or mixtures with other vitamins, such as hydrophilic vitamins, for example. Most preferred are vitamin mixtures which include at least one vitamin selected from the group consisting of vitamin A, B-carotene, vitamins D3, K1 and tocopherol.

Further embraced are formulations and preparations of a chemical or fine chemical. Formulations are, for example, solutions, mixtures, emulsions or dispersions with at least one solvent or dispersant, preferably a lipophilic solvent or dispersant. Most preferred are solutions, mixtures, emulsions or dispersions of lipophilic fine chemicals, particularly of the lipophilic vitamins—such as vitamin E acetate, vitamin A palmitate or vitamin A propionate, for example—in vegetable or synthetic oils. Vegetable oils embraces in this context, by way of example but without limitation, sunflower oil, rapeseed oil, groundnut oil, maize germ oil, and soybean oil. Synthetic oils include, in particular, medium-chain triglycerides. The chemical or fine chemical content of the solutions, mixtures, emulsions or dispersions is preferably in a range from 0.1 to 99.9% by weight, more preferably from 1 to 98% by weight, very preferably from 10 to 95%, and most preferably from 30 to 92% by weight.

The chemical or fine chemical or formulation or preparation thereof is preferably one having a liquid aggregate state. This state is preferably present even at room temperature (20° C.), but may also be obtained by raising the temperature at least to the melting point of the chemical or fine chemical or of the formulation or preparation thereof. In this case the temperature is raised to preferably to not more than 200° C., more preferably to not more than 100° C., most preferably to not more than 50° C.

Further in accordance with the invention is the packaging of foodstuffs, particularly foodstuffs which are lipophilic or which exhibit an otherwise high surface adhesion. By way of example, but without limitation, mention may be made of
a) dairy products or substitute dairy products, such as milk, cream, yoghurt, quark, soya milk, and so on,
b) pre-prepared foods or soups,
c) honey or syrup,
d) fruit juices or juice concentrates,
e) foods in oil, such as vegetables in oil (e.g., olives or chillis), cheese (e.g., sheep's milk cheese) or fish products (e.g., sardines or anchovies).

The coating compositions and polymeric molding compounds employed in the packaging materials contain as antiadhesive additive, based on the solids content of the coating composition or based on the total weight of the polymeric molding compound, from 0.1 to 10% by weight of a branched polymer possessing a weight-average molecular weight of from 2000 to 200 000 g and composed of a polymeric base molecule and also polydiorganosiloxane side chains attached covalently to the base molecule by way of Si—C bonds—directly or via a spacer—said side chains having a weight-average molecular weight of between 1000 and 30 000 g and accounting for from 5 to 25% by weight of the total weight of the branched polymer.

The polymeric base molecule of the branched polymer which is added as antiadhesive additive to the coating compositions and polymeric molding compounds is preferably a free-radical addition polymer, a polycondensate or a polyadduct and as a copolymer can also be constructed from structurally different monomeric units.

If the polymeric base molecule is a free-radical addition polymer then the monomeric units used in the base molecule can be any free-radically polymerizable, ethylenically unsaturated compounds. Preferably these are compounds which have a (meth)acrylic, a styryl, an allyl, a vinylbenzyl, a vinyl ether, a vinyl ester or a vinyl ketone group.

Particularly preferred monomeric units of the base molecule in the case of free-radical addition polymerization are selected from the group consisting of alkenes and arylalkenes having 2 to 30 carbon atoms, alkyl acrylates and alkyl methacrylates of straight-chain, branched or cycloaliphatic alcohols having 1 to 22 carbon atoms, aralkyl acrylates and aralkyl methacrylates of aralkyl alcohols having 8 to 18 carbon atoms, acrylamides and methacrylamides of straight-chain, branched or cycloaliphatic amines having 1 to 22 carbon atoms, aminoalkyl acrylates and aminoalkyl methacrylates of straight-chain, branched or cycloaliphatic amino alcohols having 2 to 8 carbon atoms, maleic esters, itaconic esters and fumaric esters of straight-chain, branched or cycloaliphatic alcohols having 1 to 22 carbon atoms, vinyl esters, vinyl ethers and vinyl ketones having 3 to 20 carbon atoms, vinyltrialkoxysilanes having 5 to 8 carbon atoms, and methacryloyloxypropyltrialkoxysilanes having 10 to 16 carbon atoms.

If the polymeric base molecule is a polycondensate then monomeric units of the base molecule that can be used include all compounds which can be condensed to form a polymer. As alcohol components for this purpose it is possible with preference to use ethylene glycol, propylene glycol, dipropylene glycol, 1,4-butanediol, 1,6-hexanediol, 2-ethylhexane-1,3-diol, neopentyl glycol, glycerol, trimethylolpropane, pentaerythritol, and dipentaerythritol. As acid components for this purpose it is possible with preference to use phthalic acid, phthalic anhydride, isophthalic acid, terephthalic acid, tetrahydrophthalic acid, tetrahydrophthalic anhydride, adipic acid, sebacic acid, maleic acid, maleic anhydride, fumaric acid, trimellitic acid, trimellitic anhydride, and pyromellitic acid and pyromellitic dianhydride. Preference extends to caprolactone and valerolactone and their derivatives, and also β-propiolactone and dodecalactone.

If the polymeric base molecule is a polyadduct then monomeric units of the base molecule that can be used include all compounds which can be linked to one another by polyaddition. Polyadducts used are preferably polyadducts of diols having 2 to 80 carbon atoms and diisocyanates, triisocyanates or polyisocyanates. All conventional aromatic, aliphatic, cycloaliphatic difunctional, trifunctional and polyfunctional isocyanates can be used. Diisocyanates used with preference are 1,6-hexamethylene diisocyanate, isophorone diisocyanate, 4,4′-biphenylene diisocyanate, tolylene diisocyanate, 4,4′-methylenedicyclohexyl diisocyanate, 1,4-diisocyanatobutane, diphenylmethane diisocyanate, and so on. Triisocyanates used with preference are triphenylmethane triisocyanate, 2,4,5-toluene triisocyanate, and the trimers of the diisocyanates, e.g., of 1,6-hexamethylene diisocyanate, and isophorone diisocyanate. Polyisocyanates such as polymethylene-polyphenyl isocyanate (PAPI) and isocyanurates (e.g., the trimers and polymers of hexamethylene diisocyanate and isophorone diisocyanate) can also be used.

As monomeric units of the base molecule it is also possible to use polyethylene glycol-containing monomeric units, in order to allow water solubility or water emulsifiability of the branched polymers. In the case of a free-radical addition polymerization of the base molecule it is possible, as polyethylene glycol-containing monomeric units, to use, for example, polyethylene glycol monoacrylates or polyethylene glycol monomethacrylates having 5 to 80 carbon atoms. Such products are particularly suitable for aqueous coating systems.

It is additionally possible to use monomeric units containing functional groups, in order to allow subsequent incorporation into the respective polymeric matrix or the binder. In the case of a free-radical addition polymerization of the base molecule it is possible, as monomeric units containing functional groups, to use, for example, acrylonitrile, acrylic acid, methacrylic acid, hydroxyalkyl acrylates or hydroxyalkyl methacrylates of straight-chain, branched or cycloaliphatic diols having 2 to 36 carbon atoms, epoxyalkyl acrylates or epoxyalkyl methacrylates of straight-chain, branched or cycloaliphatic hydroxyepoxides having 3 to 6 carbon atoms, or else vinyltrialkoxysilanes having 5 to 8 carbon atoms. Ethylenically unsaturated compounds containing an isocyanate group, such as isocyanatomethyl methacrylate or isopropenylcumyl isocyanate, for example, can also be used in a free-radical addition polymerization of the base molecule.

In order to lower greatly the surface tension of the branched polymers containing polydiorganosiloxane side chains it is advantageous to incorporate, by copolymerization, small amounts of monomeric units containing perfluoroalkyl groups. In the case of a free-radical addition polymerization of the base molecule it is possible, as monomeric units containing perfluoroalkyl groups, to use, for example, perfluoroalkyl acrylates or perfluoromethacrylates having 6 to 20 carbon atoms.

In order to ensure adequate compatibility of the branched polymers containing polydiorganosiloxane side chains with the coating compositions and/or with the polymeric molding compounds it is sensible to incorporate hydroxy and acid functionality into the branched polymer. Preference is given to branched polymers having an OH number of between 70 and 150 mg KOH/g and an acid number of between 0.5 and 30 mg KOH/g. Also possible is the incorporation of polyesters in the form of caprolactone and/or valerolactone-modified monomeric units into the polymeric base molecule. In the case of free-radical addition polymerization of the base molecule, preference is given here to caprolactone- and/or valerolactone-modified hydroxyalkyl acrylates and caprolactone and/or valerolactone-modified hydroxyalkyl methacrylates having an average molecular weight of from 220 to 1200 g, the hydroxyalkyl acrylates and the hydroxyalkyl methacrylates preferably being derived from straight-chain, branched or cycloaliphatic diols having 2 to 8 carbon atoms.

Especially preferred monomeric units of the base molecule in the case of free-radical addition polymerization are selected from the group consisting of acrylic acid, methacrylic acid, methyl acrylate, methyl methacrylate, ethyl acrylate, ethyl methacrylate, n-butyl acrylate, n-butyl methacrylate, isobutyl acrylate, isobutyl methacrylate, t-butyl acrylate, t-butyl methacrylate, lauryl acrylate, lauryl methacrylate, 2-ethylhexyl acrylate, 2-ethylhexyl methacrylate, stearyl acrylate, stearyl methacrylate, behenyl acrylate, behenyl methacrylate, cyclohexyl acrylate, cyclohexyl methacrylate, isobornyl acrylate, isobornyl methacrylate, hydroxyethyl acrylate, hydroxyethyl methacrylate, glycidyloxypropyl acrylate, glycidyloxypropyl methacrylate, vinyltriethoxy silane, methacryloyloxypropyltrimethoxysilane, isocyanatomethyl methacrylate, isopropenylcumyl isocyanate, styrene, α-methylstyrene, acrylonitrile, triethylene glycol monoacrylate, triethylene glycol monomethacrylate, ethyl vinyl ether, butyl vinyl ether, cyclohexyl vinyl ether, vinyl acetate, N,N-dimethylaminoethyl acrylate, N,N-dimethylaminoethyl methacrylate, N,N-dimethylaminopropyl acrylate, N,N-dimethylaminopropyl methacrylate, polyethylene glycol monoacrylate, polyethylene glycol monomethacrylate, and also caprolactone- and/or valerolactone-modified hydroxyethyl acrylate and caprolactone- and/or valerolactone-modified hydroxyethyl methacrylate having an average molecular weight of between 220 to 1200 g.

The polydiorganosiloxane side chains in the branched polymers added to the coating compositions and polymeric molding compounds have a weight-average molecular weight of from 1000 to 30 000 and are attached to the polymeric base molecule via an Si—C bond—directly or via a spacer. If the base molecule is a polymer from free-radical addition polymerization, then the polydiorganosiloxane side chains can be copolymerized in the form of monoethylenically unsaturated polydiorganosiloxanes (i.e., polydiorganosiloxane macromonomers). As monoethylenically unsaturated polydiorganosiloxanes it is possible, for example, to use polydiorganosiloxane mono(meth)acrylates, polydiorganosiloxane monoalkenes, and so on. If the base molecule is a polycondensate or polyadduct, then the polydiorganosiloxane groups can be copolymerized, for example, in the form of polydiorganosiloxane monools.

The term “spacer” means that the silicon atom of the polydiorganosiloxane side chain need not necessarily be linked directly to a carbon atom of the polymeric base molecule (as in form A, see below), but that other molecular building blocks as well, as illustrated for example in forms B and C, may be located between the silicon atom of the polydiorganosiloxane side chain and a carbon atom of the polymeric base molecule. The polydiorganosiloxane side chain is preferably linked—as in form B and C—to the spacer by way of an Si—C bond.

An example of a monoethylenically unsaturated polydiorganosiloxane macromonomer which can be used to incorporate a polydimethylsiloxane side chain into the polymer by copolymerization is, for instance, α-butyldimethylsiloxy-ω-(3-methacryloyloxypropyl)polydimethylsiloxane:

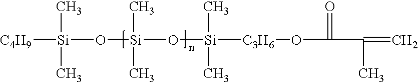

Further examples of polydimethylsiloxane side chains which may be copolymerized as polydimethylsiloxane macromonomers into the polymeric base molecule are given, for example, in the publication by Koichi Ito (1998) “Polymeric Design by Macromonomer Technique”, Prog Polym Sci 23:607ff. Also described therein is the preparation of these polydimethylsiloxanes modified at one chain end only.

In principle, however, the polydiorganosiloxane side chains may also be linked to the base molecule by reacting the polymeric base molecule with a monoterminally hydroxy-functional polydiorganosiloxane. Other monoterminally modified polydiorganosiloxanes too, such as terminally epoxy-modified polydiorganosiloxanes, for example, may be used, albeit with the proviso that the base molecule contains corresponding functional groups, such as hydroxyl groups or carboxyl groups, for instance.

An example of a monoterminally hydroxy-functional polydimethylsiloxane which can be used to incorporate a polydimethylsiloxane side chain into the polymer by reaction with the polymeric base molecule is, e.g., α-butyldimethylsiloxy-ω-(3-(2-hydroxyethoxy)propyl)polydimethylsiloxane

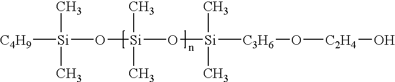

Additionally it is possible to obtain the branched polymers, for example, by transesterifying ester-containing polymers with monoterminally hydroxy-functional polydiorganosiloxanes. In this case it is also possible to use mixtures of monoterminally hydroxy-functional polydiorganosiloxanes having different chain lengths. The reaction of epoxy-functional or isocyanate-functional polymers with monoterminally hydroxy-functional and carboxy-functional polydiorganosiloxanes is a further possibility.

The preparation of the branched polymers by living free-radical addition polymerization and by group transfer polymerization is also possible.

The weight-average molecular weight of the polydiorganosiloxane side chains is between 1000 and 30 000 g, preferably between 3000 and 10 000 g. The fraction of the polydiorganosiloxane side chains in the branched polymers is between 5 and 25% by weight, preferably between 7.5 and 12.5% by weight. To prepare the branched polymers it is possible to use polydiorganosiloxane side chains of identical length or mixtures of polydiorganosiloxane side chains differing in length.

The polydiorganosiloxane side chains are preferably attached by way of a structure selected from the following structures A to C. 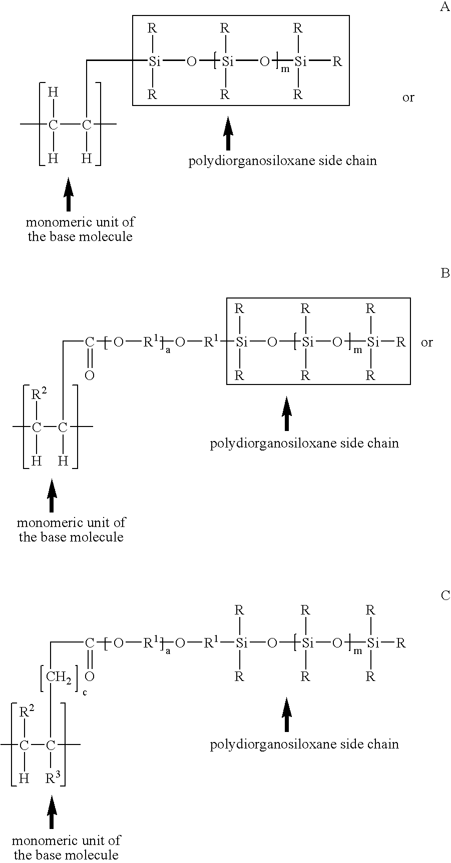
in which
the radicals R correspond to a straight-chain alkyl radical having 1 to 8 carbon atoms or a perfluoroalkyl radical having 3 to 10 carbon atoms, it being possible for the radicals R within a polydiorganosiloxane side chain to be identical or different,
the radicals R¹ correspond to a straight-chain or branched alkylene radical having 2 to 8 carbon atoms,
the radical R² corresponds to a hydrogen atom or a radical —COOR′, in which the radical R′ is a hydrogen atom or a saturated or unsaturated, straight-chain, branched or cycloaliphatic alkyl radical having 1 to 22 carbon atoms,
the radical R³, if c is 1, corresponds to a radical —COOR′ and, if c is 0, corresponds to a radical —(CH2)-COOR′ or to a methyl group, the radical R′ being as defined above,
the coefficient a may adopt a value from 0 to 10, preferably 0 to 5, and in which
m is chosen such that the molecular weight of the polydiorganosiloxane side chains is between 1000 and 30 000 g.

The weight-average molecular weights of the branched polymers are in the range from 2000 to 200 000 g, preferably from 5000 to 7000 g, more preferably in the range from 10 000 to 50 000 g.

With very particular preference the branched polymer used is the additive Silclean® 3700 (Byk-Chemie GmbH, Wesel, Germany).

The polymeric base molecules are prepared in a way which is known to the skilled worker. In the case of free-radical addition polymerization of the base molecule, for example, preparation takes place by means of peroxides or azo compounds as radical formers (free-radical polymerization initiators; also initiators below) in organic solvents or in bulk. Suitable solvents include esters, such as ethyl acetate, n-butyl acetate or 1-methoxy-2-propyl acetate, for example, and also aromatic solvents, such as toluene or xylene, for example, or else ketones, such as methyl isobutyl ketone or methyl ethyl ketone, for example. The choice of solvent is guided by the later intended use of the branched polymer. It is preferred to use low-boiling solvents in order that the solvents may be distilled off in the case of possible use of the branched polymer in pure form.

Suitable free-radical polymerization initiators include all those capable of triggering a free-radical addition polymerization. These may be peroxides, hydroperoxides, e.g., alkali metal peroxodisulfates, or azo compounds. Use is also made of combined systems composed of at least one organic reducing agent and at least one peroxide and/or hydroperoxide, examples being tert-butyl hydroperoxide with the sodium salt of hydroxymethanesulfinic acid, hydrogen peroxide with ascorbic acid or sodium peroxodisulfate with sodium disulfite. Suitable initiators are, further, the ammonium salts or alkali metal salts of peroxosulfates or peroxodisulfates, especially sodium or potassium peroxodisulfate. It is, however, also possible to use azo compounds, such as azoisobutyronitrile (AIBN). Preferred initiators are peroxides, such as tert-butyl peroxobenzoate or dibenzoyl peroxide, for example.

The polymerization is carried out at temperatures from about 40° C. to 180° C., preferably at 100° C. to 150° C., very preferably at 110° C. to 130° C.

The addition polymerization or polyaddition can be carried out in the presence of further auxiliaries (see below).

The branched polymers may also be modified subsequently by means of polymer-analogous reaction. For example, a reactive double bond and an acid function may be incorporated by reacting a branched polymer containing hydroxy-functional monomeric units in its base molecule with maleic anhydride. Further suitable anhydrides for introducing the acid function are, for example, succinic anhydride, phthalic anhydride, and trimellitic anhydride, a further possibility being the esterification of hydroxy-functional monomeric units within a branched polymer using structurally different anhydrides. For better solubility in water, the acid function may also be converted to the salt form using, for example, alkanolamines. Moreover, it is possible by subsequently acrylating and/or methacrylating the hydroxyl group to obtain products which can be incorporated securely into lacquer systems even in the case of radiation-curing operations, such as UV and electron beam curing.

The antiadhesive additives can be incorporated into coating compositions and/or molding compounds which are suitable for producing packaging materials. Said compositions/compounds are used preferably for producing interior coatings on packaging aterials, such as can interior coatings or drum interior coatings, for example.

By packaging materials are meant, generally, all vessels which are suitable, for example, for packaging, storage or transport. By way of example, but without restriction, mention may be made of drums, canisters, cans, bottles, tubes, freight containers, crates, pouches or bags. Suitable materials for such packaging include all those suitable for producing packaging materials, such as metals, glass, wood, paper, textiles, leather, plastics, and ceramics. Metals and plastics are preferred. Preferred metals are steel alloys or aluminum alloys. The packaging materials may embrace different volumes. Included are, for example, packaging materials having volumes of up to 1 l, preferably up to 10 l, more preferably up to 100 l, most preferably up to 1000 l.

The molding compounds additived using the antiadhesive additives are suitable, moreover, for the interior coating of packaging materials, such as for can interior coatings and drum interior coatings, for example.

Coating compositions include, generally speaking, all such compositions which are suitable for coating the materials used for producing packaging materials.

The coating compositions additived using the antiadhesive additives are suitable with preference for the interior coating of packaging materials, such as for can interior coatings and drum interior coatings, for example. Owing to the outstanding compatibility of the branched polymers, they are also outstandingly suitable for producing transparent coatings.

Lacquer systems in particular are suitable as coating compositions. A variety of a lacquer systems for the coating of packaging materials are known to the skilled worker.

In addition to the antiadhesive additive the coating compositions preferably include at least one binder and also, where appropriate, further components such as pigments, fillers and customary auxiliaries (see below). Coating compositions are generally characterized by the binder or binders (film former(s)) they contain. By binders are meant macromolecular substances, or macromolecule-forming substances, which are responsible for film formation. Suitable examples include 2-component reactive lacquers, air-drying lacquers, moisture-curing lacquers, acid-curing lacquers, radiation-curing lacquers, dispersion lacquers or baking lacquers.

Mention may be made, by way of example, of vinyl ester resins, polyethylene, polyamides, polyacrylonitrile, chlorinated rubber, alkyd resins, polyester resins, polyurethane resins, unsaturated polyester resins, polyester/polyisocyanate combinations (2-component), polyester acrylates (radiation-curable), acrylic resins, cellulose acetate (acetic ester of cellulose), cellulose acetobutyrate (acetic/butyric ester of cellulose), cellulose acetopropionate (acetic/propionic ester of cellulose), cellulose nitrate (nitric ester of cellulose), chlorosulfonated polyethylene, epoxy resins, epoxy resin esters, epoxy resin/tar combinations, ethylene-vinyl acetate polymers, melamine-formaldehyde resins, chlorinated polyethylene, phenol-formaldehyde resins, polymethyl methacrylate (polymethacrylic acid methyl ester), polypropylene, polytetrafluoroethylene, polyurethanes, polyurethane/tar combinations, polyvinyl acetate, polyvinyl butyral, polyvinyl chloride, chlorinated polyvinyl chloride, polyvinylidene chloride, polyvinylidene fluoride, polyvinyl fluoride, chlorinated rubber, cyclo rubber, polystyrene, polystyrene with butadiene-based elastomer, silicone polymers, saturated polyester, urea-formaldehyde resins, unsaturated polyesters, vinyl chloride-vinyl acetate polymers, polybutadiene, and so on, and also mixtures of the aforementioned.

Various preferred lacquer systems include, for example, systems based on epoxyphenol resins, alkyd resins, melamine resins, alkyd/melamine resins, phenolic resins, phenoxyphenol resins or phenol/formaldehyde resins. Of further suitability are acrylic lacquers or 2-component epoxy resin lacquers.

The polymers present in the binders may be composed by way of example of monomers such as vinyl ethers of C₃-C₁₀ alkanols, branched and unbranched C₃-C₁₀ olefins, C₁-C₁₀ alkyl acrylates, C₅-C₁₀ alkyl methacrylates, C₅-C₁₀ cycloalkyl (meth)acrylates, C₁-C₁₀ dialkyl maleates and/or C₁-C₁₀ dialkyl fumarates. Particular preference is given to ethyl acrylate, n-propyl acrylate, n-butyl acrylate, isobutyl acrylate, sec-butyl acrylate, n-hexyl acrylate, 2-ethylhexyl acrylate, n-hexyl methacrylate, 2-ethylhexyl methacrylate, di-n-butyl maleate and/or di-n-butyl fumarate. Monomers of further suitability are vinyl aromatic monomers and/or α,β-unsaturated carbonitriles or carbodinitriles. By vinyl aromatic monomers are meant, in particular, derivatives of styrene or of α-methylstyrene, in which the phenyl rings are substituted where appropriate by 1, 2 or 3 C₁-C₄ alkyl groups, chloro and/or methoxy groups. Particularly preferred monomers are styrene, α-methylstyrene, o- or p-vinyltoluene, acrylonitrile, methacrylonitrile, maleonitrile, fumaronitrile or mixtures thereof.

The binders may also contain monomers having a crosslinking action and containing at least two, nonconjugated, ethylenically unsaturated double bonds. Examples thereof are monomers containing two vinyl radicals, monomers containing two vinylidene radicals, and monomers containing two alkenyl radicals. Of particular advantage in this context are the diesters of dihydric alcohols with α,β-monoethylenically unsaturated monocarboxylic acids, among which acrylic and methacrylic acid are preferred. Examples of monomers of this kind containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates, and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate.

The coating compositions can be in a variety of presentation forms: for example, powder coating or high-solids coating materials, waterbase coating materials, radiation-curing systems.

Preference is given to systems which inherently have hydrophobic properties. Maximum preference is given to systems which are in accordance with German (BGA) or U.S. (FDA) food law.

Particular preference is given, for example, to isocyanate-crosslinking 2-component systems (cf. Example 11.1) or to baking varnishes such as acrylate/melamine baking varnishes (cf. Example 11.2) or epoxy/phenolic resin baking varnishes (cf. Example 11.3), for example.

By way of example, but without restriction, the following coating materials can be used as base coating material for the antiadhesive additives:

| Designation | Manufacturer | Color | Art. No. | Binder |
|---|---|---|---|---|
| Drum interior lacquer | DuPont | brown | 3208909100 | Phenolic resin/ |
| (R78433) | | | | epoxy combi |
| Drum exterior baking varnish | DuPont | colorless, | 380620101 | Alkyd-melamine |
| | | glossy | | resin combi |
| Drum interior lacquer | DuPont | gold | 379370101 | Phenolic resin |
| Primer | DuPont | golden brown | 379930101 | Epoxy/phenolic |
| | | | | resin combi |
| Drum interior lacquer | DuPont | reddish brown | 379380101 | Phenolic resin |
| Protefan baking varnish | Goldschmidt | gray, olive after | ′00203101 | Phenolic resin |
| 10-1 VS conc. FP > 21° C. | | baking | | |
| Protefan baking varnish | Goldschmidt | gray, olive after | ′00203131 | Phenolic resin |
| 10-1 VS conc. olive | | baking | | |
| Drum interior protection | Grace | gold | DC 1002-01 | Epoxy-phenolic |
| lacquer | | | | combi |
| Base coat N 48235 | ICI | colorless | 7011520 | Epoxy, mod. |
| Interior protection lacquer T | ICI | gold | 7010745 | Phenolic resin |
| 1/N 47929 | | | | combi |
| L-1 Clear Phenolic Hi Bake | KNS | dark amber | #114-1X | Phenolic resin |
| Concentrate | | | | |
| L-15 Dark Brown Phenolic/ | KNS | dark brown | #407-8B-N53 | Phenolic-epoxy |
| Epoxy HiBake Ready-to- | | | | resin |
| Spray | | | | |
| L-35 Dark Buff Epoxy/ | KNS | dark buff | #409-3H-J14 | Epoxy-phenolic |
| Phenolic HiBake Concentrate | | | | resin |
| L-5X Olive Drab Phenolic | KNS | olive drab | #404-5-D84 | phenolic resin |
| HiImpact HiBake Concentrate | | | | |
| L-5X Tan Phenolic HiImpact | KNS | tan | #404-5-S83 | Phenolic resin |
| HiBake Concentrate | | | | |
| L-40 X Clear Epoxy Modified | KNS | water white | #119-PF-D99 | Epoxy, mod. |
| LoVoc LoCure “Prime | | | | |
| Flex” Ready-to-Spray | | | | |
| WL-105755 tie coat | Rembrandtin | beige | 210088 | Epoxy (MG > 700) |
| WL-107031 interior protection | Rembrandtin | beige | 210094 | Epoxy (MG > 700)/ |
| lacquer | | | | phenolic resin |
| WL-105731 interior protection | Rembrandtin | yellow | 210092 | Epoxy (MG > 700)/ |
| lacquer | | | | phenolic resin |
| Wl-105701 rolling primer | Rembrandtin | gold | 210090 | Epoxy (MG > 700) |
| WL-105700 interior protection | Rembrandtin | gold lacquer | 210097 | Epoxy (MG > 700)/ |
| lacquer | | | | phenolic resin |
| WL-107910 interior protection | Rembrandtin | gold lacquer | 210096 | Epoxy (MG > 700)/ |
| lacquer | | | | phenolic resin |
| WL-106193 rolling primer | Rembrandtin | gray, approx. | 210089 | Alkyd, OH-containing |
| | | RAL 7035 | | |
| WL-105720 interior protection | Rembrandtin | reddish brown | 210091 | Phenolic resin, |
| lacquer | | | | mod. |
| Interior protection lacquer | Van Leer | gold transparent | RDL16S00VRE | Phenolic resin |
| RDL 16 (Z3) | | | | |
| Interior protection lacquer | Van Leer | gray, olive after | RDL50S00VRE | Phenolic resin |
| RDL 50 (Z42) | | baking | | |
| RDL 44 (HB19 Golden | Van Leer | yellowish | — | Epoxy-phenolic |
| Brown) | | brown | | resin |
| RDL 59 (Z4) | Van Leer | olive-green | — | Phenolic resin |
| RDL 68 | Van Leer | colorless | — | Phenoxyphenolic |
| | | | | resin |

The lacquer systems and auxiliaries can be purchased, for example, from DuPont Performance Coatings Austria GmbH VB Leipzig, Mölkau/Leipzig, Germany; Dupont Performance Coatings Austria GmbH, Guntramsdorf, Austria; Chem. Werke Kluthe GmbH, Heidelberg, Germany; Goldschmidt TIB GmbH, Mannheim, Germany; Grace Coatings, Geschäftsbereich Lacke, Norderstedt, Germany; ICI Lacke Farben GmbH, Hilden, Germany; KNS Companies Inc, Carol Stream, Ill., USA; Rembrandtin Lack Gesellschaft mbH, Vienna, Austria; Van Leer Verpackungen, Attendorn, Germany; Van Leer Nederland B. V., Vreelande, Netherlands, et seq.

The coating compositions comprise the branched polymers as antiadhesive additive in amounts of from 0.1 to 10% by weight, preferably from 0.5 to 7.5% by weight, very preferably from 1 to 5% by weight, based on the solids content of the coating composition. The branched polymers are preferably added in solution or emulsion form to the coating compositions.

The coatings can also be applied by a multicoat method to primers, surfacers or basecoats.

Processing can take place by methods such as airmix, airless, hot or compressed-air spraying, rolling, knifecoating, brushing, spraycoating, spreading, electrocoating, spincoating or roller coating. Any adjustment necessary to the processing viscosity in the case of spray or spin coating methods can be made by means of appropriate diluents.

The curing of the coating compositions is dependent on the particular type of crosslinking and can take place in a wide temperature range of, for example, −10° C. to 250° C. Surprisingly the coating compositions exhibit very good antiadhesive properties even when cured at room temperature.

The polymeric molding compounds are preferably film-forming resins, alkyd resins, polyester resins, epoxy resins, polyurethane resins, unsaturated polyester resins, epoxy resins, vinyl ester resins, polyethylene, polypropylene, polyamides, polyethylene therphthalate, PVC, polystyrene, polyacrylonitrile, polybutadiene, polyvinyl chloride or mixtures of these polymers.

The polymeric molding compounds contain the branched polymers as antiadhesive additive in amounts of from 0.1 to 10% by weight, preferably from 0.5 to 7.5% by weight, very preferably from 1 to 5% by weight, based on the total weight of the polymeric molding compounds. The branched polymers are added preferably in 100% form to the polymeric molding compounds. Alternatively they may already be present during the preparation of said compounds (for example, by addition polymerization or polyaddition).

The polymeric molding compounds can be used as they are for producing packaging materials: drums, beakers, cans, canisters or bottles, for example. The antiadhesive additive can be added both during the preparation of the polymeric molding compounds (that is, during the addition polymerization operation) and during the production of the packaging materials—at the extrusion stage, for example.

The polymeric molding compounds can be used for the coating of further materials. Thus, for example, metallic cans or drums can be coated with the additived polymeric molding compounds in the form of a polymeric interior coating.

The polymeric molding compounds can also be incorporated in composite materials. Mention may be made, by way of example but not restictively, of their use in laminated materials—such as are common knowledge in the form, for example, of the TETRAPAK® packaging forms. In this case, polymeric molding compounds, such as polyethylene, for example, and further layers where appropriate (such as aluminum, for example) are applied to paper or card in order to obtain packaging forms with high odor and flavor integrity. Corresponding materials and methods are described, for example, in EP-A 0 423 511 or EP-A 0 621 202. The antiadhesive additives can be added to the polymeric molding compounds used in these materials.

The coating compositions and polymeric molding compounds may further comprise pigments, fillers and/or further auxiliaries. Auxiliaries are substances, added generally in small amounts, which have specific chemical or technological effects. The amount of auxiliaries added is generally less than 10% in all, based on the weight of the coating composition or of the polymeric molding compound, preferably below 5% by weight, more preferably below 1% by weight, very preferably below 0.1% by weight.

The physical basis of the auxiliaries is very diverse indeed, since the intended effects, in the context of use in the coating composition, are very different. Auxiliaries can be divided into the following groups according to their function, such as, for example, wetting agents, dispersants, curing accelerators (catalysts), emulsifiers, surface-active compounds (e.g., wetting agents and dispersants), stabilizers, viscosity modifiers, binders, thickeners, preservatives, film-forming auxiliaries, hydrophobicizers, light stabilizers, aging inhibitors, leveling agents and film-forming auxiliaries (e.g., high boilers, coalescers), surface modifiers (e.g., slip additives, flatting agents), corrosion inhibitors, biocides, flame retardants, photo initiators, antiskinning agents, defoamers, adhesion promoters, and so on.

The coating compositions and polymeric molding compounds can be used pigmented or unpigmented. By pigments are meant, for example, finely divided color-imparting and/or corrosion-inhibiting powders which are virtually insoluble in the application medium.

Examples of typical inorganic pigments are titanium dioxide, preferably in the rutile form, barium sulfate, zinc oxide, zinc sulfide, zinc phosphate, basic lead carbonate, antimony trioxide, and lithopones (zinc sulfide and barium sulfate). The preparations may, however, also contain color pigments, examples being iron oxides, carbon black, graphite, luminescent pigments, zinc yellow, zinc green, ultramarine, manganese black, antimony black, manganese violet, Paris blue, pearlescent pigments or Schweinfurt green. In addition to the inorganic pigments the preparations may also include organic color pigments, e.g., sepia, gamboge, Cassel brown, toluidine red, para red, Hansa yellow, indigo, azo dyes, anthraquinonoide and indigoide dyes, and also dioxazine, quinacridone, phthalocyanine, isoindolinone and metal complex pigments.

As auxiliary material it is additionally possible to add pigment dispersants, preferably having an acid number, determined to DIN 53402, of less than 600. Suitable pigment dispersants include polyacrylic acids or copolymers of acrylic acid, methacrylic acid, maleic anhydride, itaconic acid, fumaric acid or crotonic acid with comonomers such as (meth)acrylic esters, styrene, α-olefins, maleic monoesters, and long-chain vinyl esters of the Versatic acids. Further pigment dispersants which can be used include polyphosphates, such as sodium or potassium polyphosphates. With preference use is made as pigment dispersants III of polyacrylic acids or copolymers of acrylic acid, styrene and α-methylstyrene, copolymers of acrylic acid with alkyl acrylates such as n-butyl acrylate, copolymers of maleic anhydride with C₁₀-C₃₀ α-olefins (hydrolyzed) or copolymers of maleic anhydride with styrene (hydrolyzed). Further suitable pigment dispersants include amphiphilic copolymers, prepared by polymer-analogous reaction of polymers rich in acid groups (e.g., polyacrylic acid) with long-chain alcohols, amines or epoxides, or of copolymers containing carboxylic anhydrides (e.g., maleic anhydride and styrene) with alcohols or amines.

The coating compositions and polymeric molding compounds may additionally comprise fillers. Fillers are powders which are virtually insoluble in the application medium and which impart or improve defined technological properties and endow the coating composition with more volume (fullness). Suitable inorganic fillers include in principle aluminosilicates, such as Feldspars, silicates, such as kaolin, talc, mica, magnesite, alkaline earth metal carbonates, such as calcium carbonate, in the form of calcite or chalk for example, magnesium carbonate, dolomite, alkaline earth metal sulfates, such as calcium sulfate, silicon dioxide, etc. The fillers can be used as individual components. It is also possible to employ Teflon, titanium dioxide, aluminum hydroxide, cellulose fibers, and reinforcing fibers such as glass fibers, carbon fibers, and aramid fibers. Also suitable are mixtures thereof such as calcium carbonate/kaolin, calcium carbonate/talc.

In order to adjust the film-forming properties it is possible to add what are called film-forming auxiliaries, examples being ethylene glycol, propylene glycol, butylene glycol, hexylene glycol, alkyl ethers and alkyl ether esters of glycols and polyglycols, e.g., diethylene glycol monoethyl ether, diethylene glycol monoethyl ether acetate, diethylene glycol monobutyl ether, hexylene glycol diacetate, propylene glycol monoethyl, monophenyl, monobutyl, and monopropyl ether, dipropylene glycol monomethyl ether, dipropylene glycol mono-n-butyl ether, tripropylene glycol mono-n-butyl ether, and the acetates of the aforementioned monoalkyl ethers, e.g., butoxybutyl acetate, and also alkyl esters of aliphatic monocarboxylic and dicarboxylic acids, e.g., Texanol® from Eastman, or technical-grade mixtures of dibutyl esters of succinic acid, glutaric acid, and adipic acid.

Examples of thickeners are cellulose derivatives, such as methylcellulose, hydroxyethylcellulose, and carboxymethylcellulose, and also casein, gum arabic, tragacanth gum, starch, sodium alginate, polyvinyl alcohol, polyvinylpyrrolidone, sodium polyacrylates, water-soluble copolymers based on acrylic and methacrylic acid, such as acrylic acid/acrylamide copolymers and methacrylic acid/acrylic ester copolymers, and what are called associative thickeners, examples being styrene-maleic anhydride polymers or, preferably, hydrophobically modified polyether urethanes, as described for example by Chen N et al. (1997) J Coatings Techn 69(867):73ff. and by Hester RD et al. (1997) J Coatings Techn 69(864):109ff., whose disclosure content is hereby incorporated in full by reference. Inorganic thickeners as well, bentonites or hectorite, for example, can be used.

The coating compositions may further comprise solvents. Solvents are liquids or mixtures of liquid which are able to dissolve the film-former(s). By way of example, but without restriction, mention may be made of butyl acetate, butyl glycol, white spirit, and water. When used to adjust the processing properties (viscosity) they are also called diluting agents or diluents. Paint diluents are generally mixtures of alcohols, esters, aliphatics and/or aromatics which are tailored to the particular coating materials and application methods. Examples of suitable diluents worth mentioning are V0449 (DuPont; Art No.: 38044105), HAKU 4064-1 (Kluthe; Art. No.: '0140641), HAKU 4062 (Kluthe; Art. No.: '014062), Protefan® diluent 10 T-V/F (Goldschmidt; Art. No.: '00301757).

Dispersants are generally liquid compounds which do not dissolve the film-former(s) but keep it (them) in fine, microheterogeneous distribution (dispersion, emulsion). Examples that may be mentioned include water and also, in the case of nonaqueous dispersions, hydrocarbons.

Additionally as auxiliaries it is possible to use nonionic or anionic emulsifiers. Useful nonionic emulsifiers are araliphatic or aliphatic nonionic emulsifiers, examples being ethoxylated mono-, di-, and trialkylphenols (EO units: 3 to 50, alkyl: C₄-C₉), ethoxylates of long-chain alcohols (EO units: 3 to 50, alkyl: C₈-C₃₆), and polyethylene oxide/polypropylene oxide block copolymers. Preference is given to using ethoxylates of long-chain alkanols (alkyl C₁₀-C₂₂, average degree of ethoxylation 10 to 50) and, of these, particular preference to those having a linear C₁₂-C₁₈ alkyl radical and an average degree of ethoxylation of from 10 to 50, as sole, nonionic emulsifiers. Anionic emulsifiers include for example alkali metal salts and ammonium salts of alkyl sulfates (alkyl: C₈-C₁₆), of sulfuric monoesters with ethoxylated alkanols (EO units: 2 to 50, alkyl: C₁₂ to C₁₈) and with ethoxylated alkylphenols (EO units: 3 to 50, alkyl: C₄-C₉), of alkylsulfonic acids (alkyl: C₁₂-C₁₈) and of alkylarylsulfonic acids (alkyl: C₉ to C₁₈). Further suitable emulsifiers can be found in Houben-Weyl, Methoden der organischen Chemie, Volume XIV/1, Makromolekulare Stoffe [Macromolecular Compounds], Georg-Thieme Verlag, Stuttgart, 1961, pages 192-208. Preferred anionic surface-active substances are compounds such as Dowfax® 2A1 (trade mark of the Dow Chemical Company), and also the compounds described in U.S. Pat. No. 4,269,749.

Additionally it is possible to use suitable protective colloids, such as polyvinyl alcohols, cellulose derivatives or vinylpyrrolidone copolymers, for example. A detailed description of further suitable protective colloids can be found in Houben-Weyl, Methoden der Organischen Chemie, Volume 14/1, Makromolekulare Stoffe [Macromolecular Compounds], Georg-Thieme-Verlag, Stuttgart, 1961, pp. 411-420.

The molecular weight of the copolymers used as binders can be adjusted by adding small amounts of one or more molecular weight regulator substances, examples being organic thio compounds or allyl alcohols.

Following the actual polymerization reaction for preparing an antiadhesive additive and/or a binder it is advantageous largely to free the polymers from odoriferous substances, such as residual monomers and other volatile organic components. This can be done in a manner known per se physically, by distillative removal (in particular by steam distillation) or by stripping with an inert gas. The reduction in residual monomer content can also take place chemically, by free-radical postpolymerization, in particular under the action of redox initiator systems, as set out in, for example, DE-A 44 35 423, DE-A 44 19 518, and DE-A 44 35 422. Suitable oxidizing agents for redox-initiated postpolymerization include, in particular, hydrogen peroxide, tert-butyl hydroperoxide, cumene hydroperoxide or alkali metal peroxide sulfates. Suitable reducing agents are sodium disulfite, sodium hydrogen sulfite, sodium dithionite, sodium hydroxymethanesulfinate, formamidinesulfinic acid, acetone bisulfite (addition product of sodium hydrogensulfite with acetone), ascorbic acid, and sugar compounds having a reducing action, or water-soluble mercaptans, such as mercaptoethanol. Postpolymerization with the redox initiator system is carried out in the temperature range from 10 to 100° C., preferably at 20 to 90° C. The redox partners can independently of one another be added completely, in portions or continuously over a period of from 10 minutes to 4 hours. In order to improve the postpolymerization effect of the redox initiator systems it is also possible to add soluble salts of metals of changing valence, such as iron salts, copper or vanadium salts. Complexing agents as well are frequently added, and keep the metal salts in solution under the reaction conditions.

Synthesis Examples for the Preparation of the Branched Polymers

Synthesis Examples for Branched Polymers from Free-Radical Addition Polymerization

### EXAMPLE 1

A four-neck flask provided with stirrer, thermometer, dropping funnel, top-mounted distillation apparatus, and nitrogen inlet tube is charged with 10 g of a polydimethylsiloxane macromonomer having a terminal methacrylic group and a weight-average molecular weight of 5000 g and 100 g of methoxypropyl acetate, and these components are mixed thoroughly. Nitrogen is passed over the mixture throughout the reaction. The temperature is raised to 122° C. and a mixture of 2 g of methacrylic acid, 42.7 g of isobutyl methacrylate, 26.0 g of hydroxypropyl methacrylate, 29.3 g of styrene and 1.5 g of Trigonox® C (tert-butyl peroxybenzoate, Akzo Nobel, Amersfoort, NL) is metered in over the course of four hours. Immediately after the end of the feed, 0.25 g of Trigonox C is added. After a further 30 minutes and 60 minutes, 0.25 g portions of Trigonox® C are added. Thereafter the batch is held at 122° C. for an hour. The batch is clear and viscous. The OH number of the polymer solution is approximately 53 mg KOH/g. Analyses by NMR spectroscopy show the expected signals of the polydimethylsiloxane-containing methacrylate.

### EXAMPLE 2

A four-neck flask provided with stirrer, thermometer, dropping funnel, top-mounted distillation apparatus, and nitrogen inlet tube is charged with 10 g of a polydimethylsiloxane macromonomer having a terminal methacrylic group and a weight-average molecular weight of 20 000 g and 100 g of methoxypropyl acetate, and these components are mixed thoroughly. Nitrogen is passed over the mixture throughout the reaction. The temperature is raised to 122° C. and a mixture of 2 g of methacrylic acid, 14.5 g of a caprolactone-modified hydroxyethyl acrylate (Tone M-100, Union Carbide, average molecular weight 344), 12 g of n-butyl methacrylate, 19.5 g of hydroxypropyl methacrylate, 22.8 g of styrene, 19.2 g of methyl methacrylate and 1.5 g of Trigonox® C (tert-butyl peroxybenzoate, Akzo Nobel, Amersfoort, NL) is metered in over the course of three hours. Immediately after the end of the feed, 0.25 g of Trigonox® C is added. After a further 30 minutes and 60 minutes, 0.25 g portions of Trigonox® C are added. Thereafter the batch is held at 122° C. for an hour. The batch is clear and viscous. The OH number of the polymer is approximately 53 mg KOH/g. Analyses by NMR spectroscopy show the expected signals of the polydimethylsiloxane-containing (meth)acrylate.

### EXAMPLE 3

In a four-neck flask provided with stirrer, thermometer, dropping funnel, and nitrogen inlet tube, 34.5 g of a copolymer of styrene and maleic anhydride (SMA2000, Atofina, weight-average molecular weight 2500, styrene/maleic anhydride ratio 2:1) are dissolved in 50.6 g of methoxypropyl acetate and the solution is heated to 120° C. Over 5 minutes, 3.75 g of a monoterminally hydroxy-functionally modified polydimethylsiloxane with a weight-average molecular weight of 1000 g are metered in. 30 minutes later, 12.6 g of 2-ethylhexanol are metered in over 5 minutes. Thereafter the reaction mixture is held at 120° C. for 2 hours and at 50° C. for an hour. This gives a clear product having a solids content of approximately 50%. On analysis by IR spectroscopy, anhydride is no longer detectable. The average molecular weight of the polymer is approximately 3800 g. Analyses by NMR spectroscopy show the expected signals of the polydimethylsiloxane-modified styrene/maleic monoester copolymer.

### EXAMPLE 4

A four-neck flask provided with stirrer, thermometer, dropping funnel, top-mounted distillation apparatus, and nitrogen inlet tube is charged with 10 g of a polydimethylsiloxane macromonomer having a terminal methacrylic group and a weight-average molecular weight of 5000 g and 252 g of xylene, and these components are mixed thoroughly. Nitrogen is passed over the mixture throughout the reaction. The mixture is heated to 130° C. and a mixture of 5 g of caprolactone-modified hydroxyethyl acrylate (Tone M-100, Union Carbide, average molecular weight 344), 49 g of n-butyl methacrylate, 12 g of hydroxyethyl methacrylate, 23.5 g of α-methylstyrene and 1.5 g of Trigonox® C (tert-butyl peroxybenzoate, Akzo Nobel, Amersfoort, NL) is metered in over the course of 220 minutes. When metering is at an end the reaction mixture is held at 130° C. for another hour. The batch is now milkily opaque. To remove the solvents and excess reactants the mixture is subjected to distillation under reduced vacuum. After a distillation time of 2 hours at 130° C. and a vacuum of about 20 mbar an opaque polymer is obtained in a yield of 54.5%, having a weight-average molecular weight of approximately 14 700 g. Analyses by NMR spectroscopy show the expected signals of the polydimethylsiloxane-containing (meth)acrylate.

### EXAMPLE 5

### Preparation of an Additive by Group Transfer Polymerization

Preparatory Operations: All Monomers and Solvents are Purified by Passing Them Through Glass Columns Containing Neutral Aluminia.

A well-dried four-neck flask fitted with mechanical stirrer, reflux condensor, dropping funnel, and a rubber septum is charged under a dry N₂ atmosphere with 100 g of prepurified tetrahydrofuran. Using syringes, 1.5 g of the initiator, 1-methoxy-1-trimethylsiloxy-2-methylpropene, and 0.15 ml of 1 M tetrabutylammonium 3-chlorobenzoate in acetonitrile, as catalyst, are added through the septum. Over the course of 15 minutes a mixture of 70 g of butyl methacrylate and 20 g of N,N-dimethylaminoethyl methacrylate is added dropwise to the reaction mixture. The reaction temperature is held at 40° C. with the aid of a water bath. After a subsequent reaction time of 10 minutes a further 0.15 ml of 1 M tetrabutylammomonium 3-chlorobenzoate in acetonitrile is added and over the course of 5 minutes 40 g of a 50% strength solution of a prepurified polydimethylsiloxane macromonomer having a terminal methacrylic group and a weight-average molecular weight of 1000 g in THF are added dropwise. The reaction solution is stirred for an hour without cooling, and then 3 ml of ethanol are added in order to terminate the living chain ends. This gives a slightly opaque solution of a polymer.

### EXAMPLE 6

A four-neck flask provided with stirrer, thermometer, dropping funnel, top-mounted distillation apparatus, and nitrogen inlet tube is charged with 10 g of a polydimethylsiloxane macromonomer having a terminal methacrylic group and a weight-average molecular weight of 5000 g and 100 g of DIBK, and these components are mixed thoroughly. Nitrogen is passed over the mixture throughout the reaction. The mixture is heated to 122° C. and a mixture of 15 g of caprolactone-modified hydroxyethyl acrylate (Tone M-100, Union Carbide, average molecular weight 344), 12 g of n-butyl acrylate, 20 g of hydroxyethyl methacrylate, 22.5 g of styrene, 20.5 g of methyl methacrylate and 1.5 g of Trigonox® C (tert-butyl peroxybenzoate, Akzo Nobel, Amersfoort, NL) is metered in over the course of 180 minutes. When metering is at an end the temperature is held at 122° C. Immediately after the metered addition, 30 minutes later, and a further 30 minutes later, 0.25 g portions of Trigonox® C are added. After the final addition, stirring is continued for an hour. The reaction mixture is now slightly opaque. To remove the solvent and excess reactants the mixture is subjected to distillation under reduced vacuum. After a distillation time of 90 minutes at 140° C. and a vacuum of about 20 mbar an opaque polymer is obtained in a yield of about 94%. The weight-average molecular weight was determined by means of gel permeation chromatography using polystyrene as standard to about 65 000 g.

### EXAMPLE 7

A four-neck flask provided with stirrer, thermometer, dropping funnel, top-mounted distillation apparatus, and nitrogen inlet tube is charged with 5 g of a polydimethylsiloxane macromonomer having a terminal methacrylic group and a weight-average molecular weight of 5000 g, 5 g of a polydimethylsiloxane macromonomer having a terminal methacrylic group and a weight-average molecular weight of 1000 g, 50 g of xylene and 50 g of butyl acetate, and these components are mixed thoroughly. Nitrogen is passed over the mixture throughout the reaction. The mixture is heated to 122° C. and a mixture of 15 g of a caprolactone-modified hydroxyethyl acrylate (Tone M-100, Union Carbide, average molecular weight 344), 12 g of n-butyl acrylate, 20 g of hydroxyethyl methacrylate, 22.5 g of styrene, 20.5 g of methyl methacrylate and 1.5 g of Trigonox® C (tert-butyl peroxybenzoate, Akzo Nobel, Amersfoort, NL) is metered in over the course of 180 minutes. When metering is at an end the temperature is held at 122° C. Immediately after the metered addition, 30 minutes later, and a further 30 minutes later, 0.25 g portions of Trigonox® C are added. After the final addition, stirring is continued for an hour. To remove the solvents and excess reactants the mixture is subjected to distillation under reduced vacuum. After a distillation time of 90 minutes at 140° C. and a vacuum of about 20 mbar a colorless polymer is obtained in a yield of about 99.5%. 50 g of this polymer are dissolved in a mixture of 25 g of xylene and 25 g of butyl acetate and the solution is admixed with 0.05 g of p-toluenesulfonic acid and 0.42 g of maleic anhydride. After 3 hours' heating at 90° C. anhydride is no longer detectable in the IR spectrum.

### EXAMPLE 8

50 g of the polymer solution from Example 1 with an OH number of approximately 53 mg KOH/g are admixed with 4.3 g of maleic anhydride and the mixture is heated at 90° C. with stirring for six hours. After this period of time anhydride is no longer detectable on analysis by IR spectroscopy. The result is a pale yellow-colored 56.3% strength polymer solution.

### EXAMPLE 9

### Synthesis Example for a Polycondensate

A three-neck flask provided with stirrer, thermometer, and water separator is charged with 100 g of Setal® 183 XX-60 (saturated polyester resin, in supply form of 60% strength solution in xylene, acid number 8.3 mg KOH/g, Akzo Nobel Resins, Bergen op Zoom, NL) together with 7.5 g of a polydimethylsiloxane macromonomer having a terminal hydroxyl function and a weight-average molecular weight of 10 000 g and 0.3 g of p-toluenesulfonic acid, and the components are thoroughly mixed. Thereafter the batch is boiled at reflux for about six hours until the water formed has been removed. A temperature of about 142° C. to 145° C. is established. A polymer solution yellowish brown in color is obtained. Analyses by NMR spectroscopy show the expected structures of an ester-linked polydiorganosiloxane. OH groups are not visible in the IR spectrum.

### EXAMPLE 10

### Synthesis Example for a Polyadduct

A four-neck flask provided with stirrer, thermometer, nitrogen inlet tube, and dropping funnel is charged with 50 g of n-butyl acetate, 5.38 g of Desmodur® N3300 (isocyanurate based on hexamethylene diisocyanate, NCO content 21.5%, Bayer AG, Leverkusen, Germany) and 10 g of a polydimethylsiloxane macromonomer having a terminal hydroxyl function and a weight-average molecular weight of about 1000 g (OH number 51.5 mg KOH/g). Dry nitrogen is passed over the batch throughout the reaction. The batch is heated to 60° C. Then 0.2 g of a 1% strength solution of dibutylditin laurate in xylene is added. After 30 minutes a further 0.7 g of a 1% strength solution of dibutylditin laurate in xylene is added and immediately thereafter the metered addition of a mixture of 50 g of n-butyl acetate, 25.17 g of isophorone diisocyanate, 55.79 g of Speziol C36/2 (dimer diol, OH number 205 mg KOH/g, Cognis Deutschland GmbH, Dusseldorf, Germany) and 3.2 g of 1-butanol is commenced. The mixture is added dropwise at a rate such that the temperature of the mixture does not rise above 65° C. The viscosity of the solution rises and, three hours after the end of the metered addition, free isocyanate is no longer detectable by titrimetry. A clear, colorless solution is obtained. The weight-average molecular weight is determined by means of gel permeation chromatography to be 5200 g.

### EXAMPLE 11

### Incorporation of the Antiadhesive Additives into Coating Systems

Performance testing of the antiadhesive additives took place in various coating systems.

11.1 2-Component System, Isocyanate-Crosslinking

Stock Varnish:

| | |
|---|---|
| 75.00% | Macrynal ® SM 510n (hydroxyl-containing acrylic resin, |
| | Vianova Resins, Frankfurt, Germany), 60% in |
| | xylene/solvent naphtha/butyl acetate 2:1:1 |
| 5.00% | Dowanol ® PMA |
| 5.00% | Solvesso ® 100 |
| 6.50% | Xylene |
| 8.00% | Butyl acetate |
| 0.50% | Byk ® 066 (defoamer, BYK-CHEMIE, Wesel, Germany) |
| 100.00% | |

All components are homogenized by stirring.

Curing Solution:

| | |
|---|---|
| 50.00% | Desmodur ® N3390 (polyisocyanate, Bayer AG, Leverkusen, |
| | Germany), 90% in butyl acetate/SN100 1:1 |
| 35.00% | Butyl acetate |
| 15.00% | Xylene |
| 100.00% | |

All components are homogenized by stirring. Stock varnish and curing solution are prepared independently of one another. The branched polymers prepared in Examples 1, 2, 3, 4, 6, and 7 are stirred into the stock varnish in a concentration of 2.67%, based on the solids fraction of the total coating material. Also incorporated, for comparison, are a hydroxyalkylpolydimethylsiloxane (Tegoprotect® 5000), a silicone polyacrylate (TegoProtect 5001), and a hydroxy-functional, linear, polyester-modified polydimethylsiloxane (BYK-370). Shortly before application, stock varnish and curing solution are mixed in a ratio of 2:1. Following incorporation, the additived coating materials are drawn down in a 100 μm wet film onto a primed aluminum panel, using a spiral applicator. After 30 minutes' drying at room temperature the panels are cured in a paint drying oven at 80° C. for 30 minutes. For each additived coating material, two panels are produced. One panel is washed in a laboratory dishwasher with a conventional household detergent at 80° C. After washing, the finished coated panels are conditioned at room temperature for at least 24 hours. Thereafter the treated and the untreated panels are subjected to the tests indicated below.

11.2 Acrylate/Melamine Baking Varnish

| | |
|---|---|
| 54.00% | Setalux ® C1502 (acrylate baking resin, Akzo Nobel Resins, |
| | Bergen op Zoom, Netherlands) |
| 28.00% | Maprenal ® MF600 (melamine baking resin, Vianova Resins, |
| | Frankfurt, Germany) |
| 4.00% | Shellsol ® |
| 4.00% | Solvesso ® 150 |
| 10.00% | Xylene |
| 100.00% | |

Preparation of the acrylate-melamine baking varnish: all of the components are mixed and homogenized for 10 minutes using a dissolver with a peripheral speed of 5 m/s. Thereafter the viscosity is adjusted with xylene to 24 seconds, DIN 4 mm cup. The test antiadhesive additives are incorporated over 10 minutes with a Scandex® shaker in a concentration of 2% by weight of active substance, based on the solids fraction of the coating material. For comparison, the compounds described in connection with the preparation of the baking varnish (TegoProtect® 5000, TegoProtect® 5001 and BYK-370) are added. Following incorporation, the additived coating materials are drawn down in a 100 μm wet film onto a primed aluminum panel, using a spiral applicator. After a flashoff time of 10 minutes the panels are baked at 140° C. for 20 minutes. For each additived coating aterial, two panels are produced. One panel is washed in a laboratory dishwasher with a conventional household detergent at 80° C. After washing, the finished coated panels are conditioned at room temperature for at least 24 hours. Thereafter the treated and the untreated panels are subjected to the tests indicated below.

11.3 Epoxy/Phenolic Resin Baking Varnish

An antiadhesive additive prepared in accordance with Example 1 (25% strength solution in MPAc) was added to Goldlack WL-105700 (interior protective lacquer based on epoxy (MG>700)/phenolic resin, manufacturer: Rembrandtin Lack Gesellschaft mbH, Vienna, Austria; Art. No.: 210097; lacquer in supply form), and the components were stirred together thoroughly. In a first batch, in order to obtain a final concentration of 1% of antiadhesive additive, 4% by weight of the additive formulation was used. To obtain a 2% final concentration of antiadhesive additive, 8% by weight of the additive formulation was used.

The preparation of the drums (steel drums each with a net capacity of 25 kg; Gottlieb Duttenhbfer GmbH & Co.KG, Hassloch, Germany) used in subsequent tests (see Example 13 to 16) took place by a conventional compressed-air spraying method (manual coating). Baking conditions: 8 to 10 min at a drum temperature of 210 to 220° C.

### EXAMPLE 12

### Incorporation of the Antiadhesive Additives into Polymeric Molding Compounds (Gel-Coat Mixtures)

The polymer solution from Example 8 is reacted in accordance with the table below with a gel-coat and with Butanox M-50 to form the polymeric molding compounds A and B (=gel-coat mixture A and gel-coat mixture B).

Formula (in percent by weight) for the test gel-coat mixtures:

| | Gel-coat mixture A | Gel-coat mixture B |
|---|---|---|
| Gel-Coat ® | 97 | 97 |
| (free-radical | | |
| initiator, Akzo | | |
| Nobel, Amersfoort, | | |
| NL) | | |
| Butanox ® M-50 | 2 | 2 |
| (Oldopal 733-0001, | | |
| Bufa GmbH, | | |
| Oldenburg, Germany | | |
| Polymer solution | 1 | — |
| from Example 8 | | |

The antiadhesive properties of these gel-coat mixtures are determined. This is done by first thoroughly degreasing metal vessels by washing them with ethyl acetate. After a flashoff time of 20 minutes the gel-coat mixtures A and B are applied to the interior walls of the vessels, in each case with a coat thickness of 750 μm. All of the gel-coats are cured for three days and then tested for extent of discharge in accordance with Examples 13 to 16.

### EXAMPLE 13

### Testing of Drums for Extent of Discharge of Vitamin E Acetate

Steel drums each with a net capacity of 25 kg (Gottlieb Duttenhöfer GmbH & Co.KG, Hassloch, Germany) were coated with the baking varnish Goldlack WL-105700 (interior protective lacquer based on epoxy (MG>700)/phenolic resin, manufacturer: Rembrandtin Lack Gesellschaft mbH, Vienna, Austria; Art. No.: 210097; lacquer in supply form) as described above, with and without the addition of antiadhesive additive. The lacquer for drums numbers 1 and 4 contained 1% antiadhesive additive and for drums numbers 2 and 5 2% antiadhesive additive, while drums numbers 3 and 6 were coated without the addition of antiadhesive additive. The drums were charged with food-grade vitamin E acetate (BASF Aktiengesellschaft; PN 074099). Drums 1, 2 and 3 were heated at 60° C. in an oven for about 17 h. Thereafter the drums, removed from the oven, had their contents poured out for 1 minute. After a waiting time of 3 minutes more they were emptied for a further 2 minutes and the residual content was determined.

| | Drum 1 | Drum 2 | Drum 3 |
|---|---|---|---|
| Net content | 25.02 kg | 25.04 kg | 25.04 kg |
| Residual | 0.120 kg | 0.130 kg | 0.190 kg |
| content | | | |

Drums 4, 5, and 6 were first removed from the oven and emptied for 1 minute. Subsequently the drums were heated again at 60° C. in the oven for 60 minutes, discharged again for 2 minutes, and then the residual content was determined.

| | Drum 4 | Drum 5 | Drum 6 |
|---|---|---|---|
| Net content | 25.03 kg | 25.03 kg | 25.07 kg |
| Residual | 0.03 kg | 0.03 kg | 0.09 kg |
| content | | | |

### EXAMPLE 14

### Testing of Drums for Extent of Discharge of Vitamin E Acetate

Steel drums each with a net capacity of 25 kg (Gottlieb Duttenhöfer GmbH & Co.KG, Hassloch, Germany) were coated with the aking varnish Goldlack WL-105700 (interior protective lacquer based on epoxy (MG>700)/phenolic resin, manufacturer: Rembrandtin Lack Gesellschaft mbH, Vienna, Austria; Art. No.: 210097; lacquer in supply form) as described above, with and without the addition of antiadhesive additive. The lacquer for drums numbers 1 and 4 contained 1% antiadhesive additive and for drums numbers 2 and 5 2% antiadhesive additive, while drums numbers 3 and 6 were coated without the addition of additive. The drums were charged with food-grade vitamin E acetate (BASF Aktiengesellschaft; PN 074099).

Drums 1, 2 and 3 were heated at 80° C. in an oven for about 16 h. Thereafter the drums, removed from the oven, had their contents poured out for 1 minute. After a waiting time of 3 minutes more they were emptied for a further 2 minutes and the residual content was determined.

| | Drum 1 | Drum 2 | Drum 3 |
|---|---|---|---|
| Net content | 25.03 kg | 25.08 kg | 25.00 kg |
| Residual | 0.08 kg | 0.085 kg | 0.121 kg |
| content | | | |

### EXAMPLE 15

### Testing of Drums for Extent of Discharge of Vitamin A Palmitate

Steel drums each with a net capacity of 25 kg (Gottlieb Duttenhöfer GmbH & Co.KG, Hassloch, Germany) were coated with the baking varnish Goldlack WL-105700 (interior protective lacquer based on epoxy (MG>700)/phenolic resin, manufacturer: Rembrandtin Lack Gesellschaft mbH, Vienna, Austria; Art. No.: 210097; lacquer in supply form) as described above, with and without the addition of additive. The lacquer for drums numbers 1 and 4 contained 1% antiadhesive additive and for drums numbers 2 and 5 2% antiadhesive additive, while drums numbers 3 and 6 were coated without the addition of additive. The drums were charged with feed-grade vitamin A palmitate 1.6 million (BASF Aktiengesellschaft; PN 073930). Drums 1, 2 and 3 were heated at 60° C. in an oven for about 16 h. Thereafter the drums, removed from the oven, had their contents poured out for 1 minute. After a waiting time of 3 minutes more they were emptied for a further 2 minutes and the residual content was determined.

| | Drum 1 | Drum 2 | Drum 3 |
|---|---|---|---|
| Net content | 25.02 kg | 25.025 kg | 25.018 kg |
| Residual | 0.024 kg | 0.023 kg | 0.100 kg |
| content | | | |

### EXAMPLE 16

### Testing of Drums for Extent of Discharge of Vitamin A Palmitate

Steel drums each with a net capacity of 25 kg (Gottlieb Duttenhöfer GmbH & Co.KG, Hassloch, Germany) were coated with the baking varnish Goldlack WL-105700 (interior protective lacquer based on epoxy (MG>700)/phenolic resin, manufacturer: Rembrandtin Lack Gesellschaft mbH, Vienna, Austria; Art. No.: 210097; lacquer in supply form) as described above, with and without the addition of additive. The lacquer for drums numbers 1 and 4 contained 1% antiadhesive additive and for drums numbers 2 and 5 2% antiadhesive additive, while drums numbers 3 and 6 were coated without the addition of additive. The drums were charged with ph-grade vitamin A palmitate 1.0 million (BASF Aktiengesellschaft; PN 078915).

Drums 1, 2 and 3 were heated at 60° C. in an oven for about 16 h. Thereafter the drums, removed from the oven, had their contents poured out for 1 minute. After a waiting time of 3 minutes more they were emptied for a further 2 minutes and the residual content was determined.

| | Drum 1 | Drum 2 | Drum 3 |
|---|---|---|---|
| Net content | 25.01 kg | 25.00 kg | 25.00 kg |
| Residual | 0.009 kg | 0.010 kg | 0.075 kg |
| content | | | |

1. A packaging material for packaging chemicals or foodstuffs, with the exception of mineral and vegetable oils, comprising at least one coating composition having antiadhesive properties which comprises as an additive from 0.1 to 10% by weight, based on the solids fraction of the coating composition, of a branched polymer which possesses a weight-average molecular weight of from 2,000 to 200,000 g and is composed of:
(a) a polymeric base molecule; and
(b) polydiorganosiloxane side chains covalently attached to the polymeric base molecule.

2. The packaging materials material of claim 1, further comprising at least one polymeric molding compound having antiadhesive properties which comprises as additive from 0.1 to 10% by weight of the branched polymer, based on the total weight of the polymeric molding compound.

3. The packaging material of claim 1, wherein the chemicals comprise lipophilic chemicals or fine chemicals.

4. The packaging material of claim 3, wherein the fine chemicals are selected from the group consisting of vitamins, fatty acids, fragrances, flavors, aromas, colorants, pharmaceutical chemicals, agrochemicals, cosmetic chemicals, and their precursors, intermediates, formulations and preparations.

5. The packaging material of claim 1, wherein the foodstuffs are selected from the group consisting of dairy products, pre-prepared foods or soups, honey, syrup, fruit juices, juice concentrates, and foods in oil.

6. The packaging material of claim 1, wherein the polydiorganosiloxane side chains are attached to the base molecule via a structure selected from the structures: 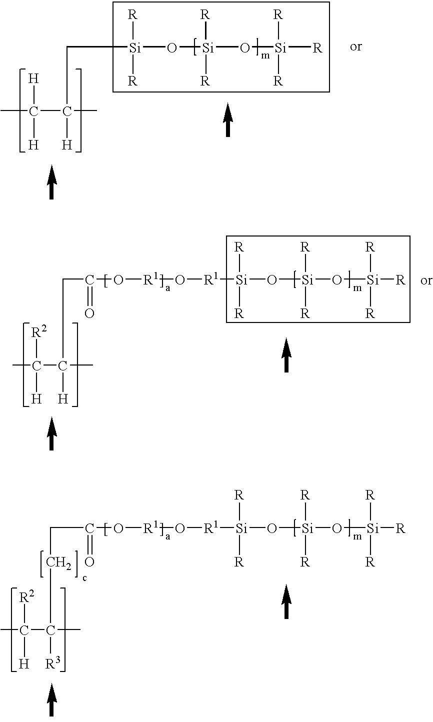
in which R is a straight-chain alkyl radical having 1 to 8 carbon atoms or a perfluoroalkyl radical having 3 to 10 carbon atoms, and the R groups within the polydiorganosiloxane side chains are identical or different,
R¹ is a straight-chain or branched alkylene radical having 2 to 8 carbon atoms,
R² is a hydrogen atom or a radical —COOR′, in which R′ is a hydrogen atom or a saturated or unsaturated, straight-chain, branched or cycloaliphatic alkyl radical having 1 to 22 carbon atoms,
c is 0 or 1,
R³, if c is 1, is —COOR′ and, if c is 0, is —(CH2)-COOR′ or to a methyl group, in which R′ is a hydrogen atom or a saturated or unsaturated, straight-chain, branched or cycloaliphatic alkyl radical having 1 to 22 carbon atoms, and
a is a value from 0 to 10, and in which m is-chosen such that the molecular weight of the polydiorganosiloxane side chains is between 1,000 and 30,000 g.

7. The packaging material of claim 1, wherein the polydiorganosiloxane side chains are attached in the form of a monoisocyanate adduct to the polymeric base molecule.

8. The packaging material of claim 1, wherein the base molecule, as a polymer from free-radical addition polymerization, is composed of monomeric units selected from the group consisting of alkenes and arylalkenes having 2 to 30 carbon atoms, alkyl acrylates and alkyl methacrylates of straight-chain, branched or cycloaliphatic alcohols having 1 to 22 carbon atoms, aralkyl acrylates and aralkyl methacrylates of aralkyl alcohols having 8 to 18 carbon atoms, polyethylene glycol monoacrylates or polyethylene glycol monomethacrylates having 5 to 80 carbon atoms, hydroxyalkyl acrylates and hydroxyalkyl methacrylates of straight-chain, branched or cycloaliphatic diols having 2 to 36 carbon atoms, epoxyalkyl acrylates or epoxyalkyl methacrylates of straight-chain, branched or cycloaliphatic hydroxyepoxides having 3 to 6 carbon atoms, acrylamides and methacrylamides of straight-chain, branched or cycloaliphatic amines having 1 to 22 carbon atoms, aminoalkyl acrylates and aminoalkyl methacrylates of straight-chain, branched or cycloaliphatic amino alcohols having 2 to 8 carbon atoms, maleic esters, itaconic esters and fumaric esters of straight-chain, branched or cycloaliphatic alcohols having 1 to 22 carbon atoms, perfluoroalkyl acrylates and perfluoroalkyl methacrylates having 6 to 20 carbon atoms, vinyl esters, vinyl ethers and vinyl ketones having 3 to 20 carbon atoms, vinyltrialkoxysilanes having 5 to 8 carbon atoms, methacryloyloxypropyltrialkoxysilanes having 10 to 16 carbon atoms, and caprolactone and valerolactone-modified hydroxyalkyl acrylates and methacrylates having an average molecular weight of from 220 to 1200 g, and hydroxyalkyl acrylates and hydroxyalkyl methacrylates derived from straight-chain, branched or cycloaliphatic diols having 2 to 8 carbon atoms.

9. The packaging material of claim 1, wherein the polymeric base molecule is formed by free-radical addition polymerization of monomeric units selected from the group consisting of acrylic acid, methacrylic acid, methyl acrylate, methyl methacrylate, ethyl acrylate, ethyl methacrylate, n-butyl acrylate, n-butyl methacrylate, isobutyl acrylate, isobutyl methacrylate, t-butyl acrylate, t-butyl methacrylate, lauryl acrylate, lauryl methacrylate, 2-ethylhexyl acrylate, 2-ethylhexyl methacrylate, stearyl acrylate, stearyl methacrylate, behenyl acrylate, behenyl methacrylate, cyclohexyl acrylate, cyclohexyl methacrylate, isobomyl acrylate, isobomyl methacrylate, hydroxyethyl acrylate, hydroxyethyl methacrylate, glycidyloxypropyl acrylate, glycidyloxypropyl methacrylate, vinyltriethoxy silane, methacryloyloxypropyltrimethoxysilane, isocyanatomethyl methacrylate, isopropenylcumyl isocyanate, styrene, α-methylstyrene, acrylonitrile, triethylene glycol monoacrylate, triethylene glycol monomethacrylate, ethyl vinyl ether, butyl vinyl ether, cyclohexyl vinyl ether, vinyl acetate, N,N-dimethylaminoethyl acrylate, N,N-dimethylaminoethyl methacrylate, N,N-dimethylaminopropyl acrylate, N,N-dimethylaminopropyl methacrylate, polyethylene glycol monoacrylate, polyethylene glycol monomethacrylate, and caprolactone and valerolactone-modified hydroxyethyl acrylate and methacrylate having an average molecular weight of between 220 and 1200 g.

10. The packaging material of claim 1, wherein the fraction of the polydiorganosiloxane side chains as a proportion of the total weight of the branched polymer is from 5 to 20% by weight.

11. The packaging material of claim 1, wherein the fraction of the polydiorganosiloxane side chains as a proportion of the total weight of the branched polymer is from 7.5 to 12.5% by weight.

12. The packaging material of claim 1, wherein functional hydroxyl groups present in the polymeric base molecule are esterified with a compound selected from the group consisting of maleic anhydride, succinic anhydride, phthalic anhydride, trimellitic anhydride, acrylic acid, and methacrylic acid.

13. The packaging material of claim 1, wherein the branched polymer possesses a weight-average molecular weight of from 5,000 to 75,000 g.

14. The packaging material of claim 1, wherein the at least one coating composition further contains a polymeric molding compound.

15. The packaging material of claim 14, wherein the polymeric molding compound is selected from the group comprising film-forming resins, alkyd resins, polyester resins, epoxy resins, polyurethane resins, unsaturated polyester resins, vinyl ester resins, polyethylene, polypropylene, polyamides, polyethylene therephthalate, PVC, polystyrene, polyacrylonitrile, polybutadiene, polyvinyl chloride and mixtures of these polymers.

16. The packaging material of claim 1, wherein the at least one coating composition comprises a binder selected from the group consisting of vinyl ester resins, polyethylene, polyamides, polyacrylonitrile, chlorinated rubber, alkyd resins, polyester resins, polyurethane resins, unsaturated polyester resins, polyester/polyisocyanate combinations, polyester acrylates, acrylic resins, cellulose acetate, cellulose acetobutyrate, cellulose acetopropionate, cellulose nitrate, chlorosulfonated polyethylene, epoxy resins, epoxy resin esters, epoxy resin/tar combinations, ethylene-vinyl acetate polymers, melamine-formaldehyde resins, chlorinated polyethylene, phenol-formaldehyde resins, polymethyl methacrylate, polypropylene, polystyrene, polytetrafluoroethylene, polyurethanes, polyurethane/tar combinations, polyvinyl acetate, polyvinyl butyral, polyvinyl chloride, chlorinated polyvinyl chloride, polyvinylidene chloride, polyvinylidene fluoride, polyvinyl fluoride, chlorinated rubber, cyclo rubber, polystyrene, polystyrene with butadiene-based elastomer, silicone polymers, saturated polyester, urea-formaldehyde resins, unsaturated polyesters, vinyl chloride-vinyl acetate polymers, polybutadiene and mixtures of the aforementioned.

17. The packaging material of claim 1, further comprising a spacer which has a weight-average molecular weight of between 1,000 and 30,000 g, and whose fraction as a proportion of the total weight of the branched polymer is from 5 to 25% by weight.

18. The packaging material of claim 1, wherein polydiorganosiloxane side chains are covalently attached to the polymeric base molecule by Si—C bonds.

19. The packaging material of claim 1, wherein the branched polymer is present at from 0.5% to 5% by weight, based on the solids fraction of the at least one coating composition.

20. The packaging material of claim 14, wherein the polymeric molding compound is present at from 0.5 to 5% by weight, based on the solids fraction of the at least one coating composition.

21. The packaging material of claim 1, which comprises one or more of the physical properties of corrosion protection, gloss retention, weathering stability, and food-contact integrity.

22. A method comprising packaging chemicals or foodstuffs, but not minerals or vegetable oils, with a material comprising a coating composition having antiadhesive properties which comprises as an additive from 0.1 to 10% by weight, based on the solids fraction of the coating composition, of a branched polymer which possesses a weight-average molecular weight of from 2,000 to 200,000 g and is composed of a polymeric base molecule comprising a plurality of monomeric units and a polydiorganosiloxane side chain covalently attached to each monomeric unit.

23. The method of claim 22, wherein the material further comprises a polymeric molding compound having an antiadhesive property.

24. The method of claim 23, wherein the polymeric molding compound is present as an additive at from 0.1 to 10% by weight, based on the total weight of the solids fraction of the coating composition.

25. The method of claim 23, wherein the polymeric molding compound is selected from the group comprising film-forming resins, alkyd resins, polyester resins, epoxy resins, polyurethane resins, unsaturated polyester resins, vinyl ester resins, polyethylene, polypropylene, polyamides, polyethylene therephthalate, PVC, polystyrene, polyacrylonitrile, polybutadiene, polyvinyl chloride and mixtures of these polymers.

26. The method of claim 23, wherein the polymeric molding compound is present at from 0.5% to 5% by weight, based on the solids fraction of the coating composition.

27. The method of claim 22, wherein the branched polymer is present at from 0.5 to 5% by weight, based on the solids fraction of the coating composition.

28. The method of claim 22, wherein the chemicals comprise lipophilic chemicals or fine chemicals.

29. The method of claim 28, wherein the fine chemicals are selected from the group consisting of vitamins, fatty acids, fragrances, flavors, aromas, colorants, pharmaceutical chemicals, agrochemicals, cosmetic chemicals, and their precursors, intermediates, formulations and preparations.

30. The method of claim 22, wherein the foodstuffs are selected from the group consisting of dairy products, pre-prepared foods or soups, honey, syrup, fruit juices, juice concentrates, and foods in oil.

31. The method of claim 22, wherein the polydiorganosiloxane side chain is attached to each monomeric unit via a structure selected from the structures: 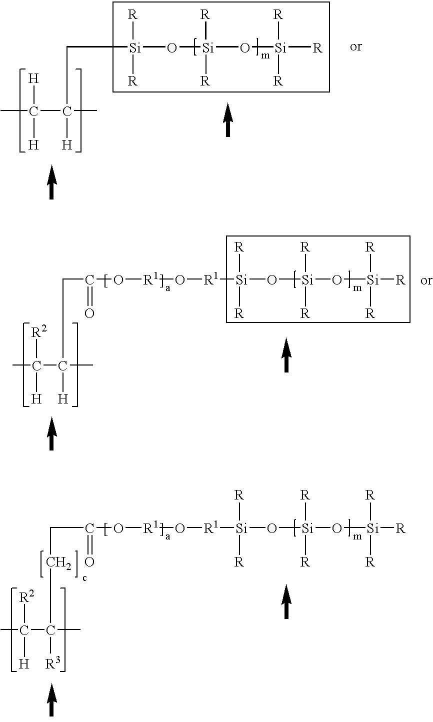
in which R is a straight-chain alkyl radical having 1 to 8 carbon atoms or a perfluoroalkyl radical having 3 to 10 carbon atoms, and the R groups within the polydiorganosiloxane side chain are identical or different,
R¹ is a straight-chain or branched alkylene radical having 2 to 8 carbon atoms,
R² is a hydrogen atom or a radical —COOR′, in which R′ is a hydrogen atom or a saturated or unsaturated, straight-chain, branched or cycloaliphatic alkyl radical having 1 to 22 carbon atoms,
c is 0 or 1,
R³, if c is 1, is —COOR′ and, if c is 0, is —(CH2)-COOR′ or to a methyl group, in which R′ is a hydrogen atom or a saturated or unsaturated, straight-chain, branched or cycloaliphatic alkyl radical having 1 to 22 carbon atoms, and
a is a value from 0 to 10, and in which m is chosen such that the molecular weight of the polydiorganosiloxane side chains is between 1,000 and 30,000 g.

32. The method of claim 22, wherein the polydiorganosiloxane side chain is covalently attached in the form of a monoisocyanate adduct to the polymeric base molecule.

33. The method of claim 22, wherein the monomeric units are selected from the group consisting of alkenes and arylalkenes having 2 to 30 carbon atoms, alkyl acrylates and alkyl methacrylates of straight-chain, branched or cycloaliphatic alcohols having 1 to 22 carbon atoms, aralkyl acrylates and aralkyl methacrylates of aralkyl alcohols having 8 to 18 carbon atoms, polyethylene glycol monoacrylates or polyethylene glycol monomethacrylates having 5 to 80 carbon atoms, hydroxyalkyl acrylates and hydroxyalkyl methacrylates of straight-chain, branched or cycloaliphatic diols having 2 to 36 carbon atoms, epoxyalkyl acrylates or epoxyalkyl methacrylates of straight-chain, branched or cycloaliphatic hydroxyepoxides having 3 to 6 carbon atoms, acrylamides and methacrylamides of straight-chain, branched or cycloaliphatic amines having 1 to 22 carbon atoms, aminoalkyl acrylates and aminoalkyl methacrylates of straight-chain, branched or cycloaliphatic amino alcohols having 2 to 8 carbon atoms, maleic esters, itaconic esters and fumaric esters of straight-chain, branched or cycloaliphatic alcohols having 1 to 22 carbon atoms, perfluoroalkyl acrylates and perfluoroalkyl methacrylates having 6 to 20 carbon atoms, vinyl esters, vinyl ethers and vinyl ketones having 3 to 20 carbon atoms, vinyltrialkoxysilanes having 5 to 8 carbon atoms, methacryloyloxypropyltrialkoxysilanes having 10 to 16 carbon atoms, caprolactone and valerolactone-modified hydroxyalkyl acrylates and methacrylates having an average molecular weight of from 220 to 1200 g, and hydroxyalkyl acrylates and hydroxyalkyl methacrylates derived from straight-chain, branched or cycloaliphatic diols having 2 to 8 carbon atoms.

34. The method of claim 22, wherein the monomeric units are selected from the group consisting of acrylic acid, methacrylic acid, methyl acrylate, methyl methacrylate, ethyl acrylate, ethyl methacrylate, n-butyl acrylate, n-butyl methacrylate,
isobutyl acrylate, isobutyl methacrylate, t-butyl acrylate, t-butyl methacrylate, lauryl acrylate, lauryl methacrylate, 2-ethylhexyl acrylate, 2-ethylhexyl methacrylate, stearyl acrylate, stearyl methacrylate, behenyl acrylate, behenyl methacrylate, cyclohexyl acrylate, cyclohexyl methacrylate, isobomyl acrylate, isobomyl methacrylate, hydroxyethyl acrylate, hydroxyethyl methacrylate, glycidyloxypropyl acrylate, glycidyloxypropyl methacrylate, vinyltriethoxy silane, methacryloyloxypropyltrimethoxysilane, isocyanatomethyl methacrylate, isopropenylcumyl isocyanate, styrene, α-methylstyrene, acrylonitrile, triethylene glycol monoacrylate, triethylene glycol monomethacrylate, ethyl vinyl ether, butyl vinyl ether, cyclohexyl vinyl ether, vinyl acetate, N,N-dimethylaminoethyl acrylate, N,N-dimethylaminoethyl methacrylate, N,N-dimethylaminopropyl acrylate, N,N-dimethylaminopropyl methacrylate, polyethylene glycol monoacrylate, polyethylene glycol monomethacrylate, caprolactone and valerolactone-modified hydroxyethyl acrylates, and caprolactone and valerolactone-modified hydroxyethyl methacrylates having an average molecular weight of between 220 and 1200 g.

35. The method of claim 22, wherein the fraction of polydiorganosiloxane side chains as a proportion of the total weight of the branched polymer is from 5 to 20% by weight.

36. The method of claim 22, wherein the fraction of polydiorganosiloxane side chains as a proportion of the total weight of the branched polymer is from 7.5 to 12.5% by weight.

37. The method of claim 22, wherein functional hydroxyl groups present in the polymeric base molecule are esterified with a compound selected from the group consisting of maleic anhydride, succinic anhydride, phthalic anhydride, trimellitic anhydride, acrylic acid, and methacrylic acid.

38. The method of claim 22, wherein the branched polymer possesses a weight-average molecular weight of from 5,000 to 75,000 g.

39. The method of claim 22, wherein the coating composition further comprises a binder selected from the group consisting of vinyl ester resins, polyethylene, polyamides, polyacrylonitrile, chlorinated rubber, alkyd resins, polyester resins, polyurethane resins, unsaturated polyester resins, polyester/polyisocyanate combinations, polyester acrylates, acrylic resins, cellulose acetate, cellulose acetobutyrate, cellulose acetopropionate, cellulose nitrate, chlorosulfonated polyethylene, epoxy resins, epoxy resin esters, epoxy resin/tar combinations, ethylene-vinyl acetate polymers, melamine-formaldehyde resins, chlorinated polyethylene, phenol-formaldehyde resins, polymethyl methacrylate, polypropylene, polystyrene, polytetrafluoroethylene, polyurethanes, polyurethane/tar combinations, polyvinyl acetate, polyvinyl butyral, polyvinyl chloride, chlorinated polyvinyl chloride, polyvinylidene chloride, polyvinylidene fluoride, polyvinyl fluoride, chlorinated rubber, cyclo rubber, polystyrene, polystyrene with butadiene-based elastomer, silicone polymers, saturated polyester, urea-formaldehyde resins, unsaturated polyesters, vinyl chloride-vinyl acetate polymers, polybutadiene and mixtures of the aforementioned.

40. The method of claim 22, further comprising a spacer having a weight-average molecular weight of between 1,000 and 30,000 g, and whose fraction as a proportion of the total weight of the branched polymer is from 5 to 25% by weight.

41. The method of claim 22, wherein polydiorganosiloxane side chains are covalently attached to the polymeric base molecule by Si—C bonds.

42. The method of claim 22, wherein the material possesses one or more of the physical properties of corrosion protection, gloss retention, weathering stability, and food-contact integrity.

43. A method for manufacturing a material for packaging chemicals or foodstuffs, but not minerals or vegetable oils, comprising providing a material comprising a coating composition having antiadhesive properties which comprises from 0.1 to 10% by weight of a branched polymer, based on the solids fraction of the coating composition, possessing a weight-average molecular weight of from 2,000 to 200,000 g and composed of a polymeric base molecule containing monomeric units, with polydiorganosiloxane side chains covalently attached to the monomeric units.
